(19) United States
(12) Patent Application Publication
(10) Pub. No.: US 2022/0156617 A1
(43) Pub. Date: May 19, 2022

(54) MULTI-DIMENSIONAL AIRCRAFT COLLISION CONFLICT RISK EVALUATION SYSTEM

(71) Applicant: CIVIL AVIATION FLIGHT UNIVERSITY OF CHINA, Guanghan (CN)

(72) Inventors: Weijun PAN, Guanghan (CN); Siyu WANG, Guanghan (CN); Kuanming CHEN, Guanghan (CN); Xiaolei ZHANG, Guanghan (CN); Xuan WANG, Guanghan (CN); Jiayang CHEN, Guanghan (CN); Jingyu LIAN, Guanghan (CN)

(21) Appl. No.: 17/586,407

(22) Filed: Jan. 27, 2022

Related U.S. Application Data
(63) Continuation of application No. PCT/CN2020/110222, filed on Aug. 20, 2020.

(30) Foreign Application Priority Data
Mar. 30, 2020 (CN) 202010237759.7

(51) Int. Cl. G06N 7/00

(52) U.S. Cl. CPC G06N 7/005

(57) ABSTRACT

A multi-dimensional aircraft collision risk evaluation system in the field of collision prediction for civil aviation aircraft is disclosed. The system calculates probabilities of overlapping between an aircraft and one or more other aircraft in three dimensions; calculates loss interval rates of the aircraft in three dimensions; obtains probabilities of collision between the aircraft in directions corresponding to the three dimensions; compares the probabilities of collision in the three dimensions of the aircraft to obtain a maximum probability and a dimension corresponding to the maximum probability; and calculates a difference value between the maximum probability and a safety standard, and making or giving a safety evaluation according to the difference value. Accordingly, the calculation of the multi-dimensional aircraft collision risk probability is realized. The maximum collision risk probability is calculated, and a determination criterion for a comprehensive safety evaluation of the aircraft is provided based on the maximum collision risk probability.

### CROSS-REFERENCE TO RELATED APPLICATIONS

This application is a continuation of and claims priority to PCT/CN2020/110222, filed on Aug. 20, 2020, which claims priority to Chinese Patent Application No. 202010237759.7, filed on Mar. 30, 2020, the entireties of which are both hereby incorporated by reference.

### TECHNICAL FIELD

The present invention relates to the field of collision prediction for civil aviation aircraft, in particular to a multi-dimensional aircraft collision risk evaluation system.

### BACKGROUND

With the continuous development of civil aviation in our country, safety importance of the civil aviation has been received more and more attentions. With the increase in the quantity of flights and routes, the interval distance between aircraft is reduced under the RECAT standard. Our researches focus on how to ensure that these improved interval distances are safe, and how to ensure that the collision risk of the aircraft is not within the prescribed safety risks at any time.

In 2010, Xiaowen Cao proposed a lateral collision risk study (Xiaowen Cao, EVENT model-based lateral collision risk study [J]. Technology and Market, 2010, 17(02):14.) by using an EVENT model. On the basis of a Reich collision risk model, an EVENT-based lateral collision risk model is established. Then, through instances, the impact of lateral intervals on collision risk is analyzed.

However, there is no improvement on the model in the study of Xiaowen Cao, so that the current situation that a large amount of statistical data is required for the calculation of a collision probability result by applying an EVENT model formula is not changed. In addition, the research on the collision probability of the aircraft is merely limited to lateral research, but the aircraft are dynamic during operation, speed exists in all directions, and collision may occur in all directions, so that the research is one-sided.

### SUMMARY

In order to overcome the above defects that there is only lateral calculation for aircraft collision probability calculation, in the present invention, a model for calculating multi-dimensional aircraft collision risk probabilities is expanded, and a multi-dimensional aircraft collision risk evaluation system is provided.

In order to implement the above objective, the present invention provides the following technical solutions.

Disclosed is a multi-dimensional aircraft collision risk evaluation system, configured to execute the following steps:

S1, calculating probabilities of overlapping between an aircraft and other aircraft in three dimensions according to model size parameters of the aircraft, distances between the aircraft and the other aircraft in three dimension directions and a standard deviation of a yaw distance;

S2, calculating loss interval rates of the aircraft in three dimensions according to the probabilities of overlapping between the aircraft and the other aircraft in three dimensions;

S3, obtaining probabilities of collision between the aircraft and the other aircraft in the three dimension directions according to frequencies of loss interval per hour of the aircraft in the three dimension directions, a model speed difference value between the aircraft and other surrounding aircraft, model sizes, logarithms of the aircraft flying in a same direction and in an opposite direction and a collision probability of the aircraft at a same flight level in a perpendicular direction;

S4, comparing the probabilities of collision of the aircraft in the three dimension directions to obtain a maximum probability and a dimension corresponding to the maximum probability; and

S5, calculating a difference value between the obtained maximum probability and a safety standard, and giving a safety evaluation according to the difference value.

Further, the probabilities of overlapping between the aircraft and the other aircraft in three dimensions are respectively calculated as follows:

a calculation formula of the probability of overlapping between the aircraft in an X-axis direction is

P_{Y}(S_{Y})=∫_{-D}_{₁}^{+D}^{₁}fₛ(x)dx

where D₁=planeA wingspan/2+planeB wingspan/2, S_{Y}=f_{S}(x) is a probability density function, which obeys a normal distribution and used to represent a longitudinal distance between the aircraft in the X-axis direction;

a calculation formula of the probability of overlapping between the aircraft in a Z-axis direction is

P_{Z}(S_{Z})=∫_{-D2}^{+D}^{₂}fₛ(z)dx

where D₂=planeA altitude/2+planeB altitude/2, S_{Z}=fₛ(z) is a probability density function, which obeys a normal distribution and used to represent a perpendicular distance between the aircraft in the Z-axis direction; and

a calculation formula of the probability of overlapping between the aircraft in a Y-axis direction is

P_{X}(S_{X})=∫_{-D3}^{+D3}fₛ(y)dy

where D₃=planeA length/2+planeB length/2, S_{X}=fₛ(y) is a probability density function, which obeys a normal distribution and used to represent a longitudinal distance between the aircraft in the Y-axis direction.

As a preferred solution, fₛ(x) is calculated as follows:

$${f}_{s} ( x ) = \frac{1}{{σ}_{d} \sqrt{2 π}} {e}^{\frac{\text{?}}{\text{?}}}$$

$$\text{?} \text{indicates text missing or illegible when filed}$$

where a₁ and a₂ are initial lateral distances of two aircraft that initially pass through a navigation station, and σ_{d} is a standard deviation of a lateral aircraft yaw distance when a distance from the aircraft to the navigation station is d.

As a preferred solution, fₛ(z) is calculated as follows:

$${f}_{s} ( Z ) = \frac{1}{{γ}_{t} \sqrt{2 π}} {e}^{\frac{\text{?} {( Z - ( {H}_{2} - {H}_{1} ) )}^{2}}{\text{?}}}$$

$$\text{?} \text{indicates text missing or illegible when filed}$$

where H₂ and H₁ are initial perpendicular altitudes of two aircraft that initially pass through the navigation station, and γₜ is a standard deviation of an altitude distance of the aircraft after flight time T.

As a preferred solution, fₛ(y) is calculated as follows:

$${f}_{s} ( y ) = \frac{1}{{κ}_{t} \sqrt{2 π}} {e}^{\frac{\text{?}}{\text{?}}}$$

$$\text{?} \text{indicates text missing or illegible when filed}$$

where Y₂ and Y₁ are longitudinal distances of two aircraft that initially pass through a navigation station, and κₜ is a standard deviation of a longitudinal distance of the aircraft after flight time T.

Further, in the step S2, the frequencies of loss interval per hour of the aircraft in the three dimension directions are calculated according to three dimensions, i.e., an X axis, a Y axis and a Z axis, calculation formulas being as follows:

### The X Axis:

$$GERH 1 \times ( 2 \frac{λ \text{?}}{V} ) = {P}_{Y} ( {S}_{Y} )$$

$$\text{?} \text{indicates text missing or illegible when filed}$$

### The Z Axis:

$$GERH 2 \times ( 2 \frac{λ \text{?}}{W} ) = {P}_{Z} ( {S}_{Z} )$$

$$\text{?} \text{indicates text missing or illegible when filed}$$

### The Y Axis:

$$FERH 3 \times ( 2 \frac{λ \text{?}}{U} ) = {P}_{X} ( {S}_{X} )$$

$$\text{?} \text{indicates text missing or illegible when filed}$$

where GERH1 represents the frequency of loss interval per hour in a lateral direction, GERH2 represents the frequency of loss interval per hour in the perpendicular direction, GERH3 represents the frequency of loss interval per hour in a longitudinal direction, U, V and W are relative speeds in longitudinal, lateral and perpendicular directions of an aircraft A passing through an interval region of an aircraft B when the aircraft fly in the same direction, λ_{X}, λ_{Y} and λ_{Z} are a length, a width and a height of a collision box wrapping a real shape of the aircraft, and P_{Y}(S_{Y}), P_{Z}(S_{Z}) and P_{X}(S_{X}) successively are a lateral overlapping probability, a perpendicular overlapping probability and a longitudinal overlapping probability.

As a preferred solution, in the step S3, the collision probabilities of the aircraft in the three dimension directions are respectively calculated according to an X axis, a Y axis and a Z axis,

### The X Axis:

$$F \text{?} = GERh 1 E ( S ) {P}_{Z} ( 0 ) ( \frac{λ \text{?}}{\text{?} L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} ) + GERH 1 E ( 0 ) {P}_{Z} ( 0 ) ( \frac{λ \text{?}}{L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} )$$

$$\text{?} \text{indicates text missing or illegible when filed}$$

### The Z Axis:

$$F \text{?} = GERh 2 E ( S ) {P}_{Z} ( 0 ) ( \frac{λ \text{?}}{\text{?} L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} ) + GERH 2 E ( 0 ) {P}_{Z} ( 0 ) ( \frac{λ \text{?}}{L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} )$$

$$\text{?} \text{indicates text missing or illegible when filed}$$

### The Y Axis:

$$F \text{?} = GERh 3 E ( S ) {P}_{Z} ( 0 ) ( \frac{λ \text{?}}{\text{?} L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} ) + GERH 3 E ( 0 ) {P}_{Z} ( 0 ) ( \frac{λ \text{?}}{L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} )$$

$$\text{?} \text{indicates text missing or illegible when filed}$$

where GERH1, GERH2 and GERH3 are the frequencies of loss interval per hour in the lateral, perpendicular and longitudinal directions; P_{Z}(0) is the probability of overlapping of two aircraft at a same flight level; λ_{X}, λ_{Y} and λ_{Z} are a length, a width and a height of a collision box wrapping a real shape of the aircraft; U₁, V₁ and W₁ are relative speeds of the aircraft in the longitudinal, lateral and perpendicular directions in a process that an aircraft A, flying in the same direction, passes through an interval region of an aircraft B when the problem about a longitudinal distance is evaluated; U₂, V₂ and W₂ are relative speeds of the aircraft in the longitudinal, lateral and perpendicular directions in a process that the aircraft A, flying in the same direction, passes through the interval region of the aircraft B when the problem about a perpendicular distance is evaluated; U₃, V₃ and W₃ are relative speeds of the aircraft in the longitudinal, lateral and perpendicular directions in a process that the aircraft A, flying in the same direction, passes through the interval region of the aircraft B when the problem about a longitudinal distance is evaluated; L is a longitudinal interval; and E(S) and E(0) respectively are logarithms of the aircraft flying in the same direction and in the opposite direction.

Further, the step S5 specifically includes:

subtracting a safety standard value from the obtained maximum probability to obtain a difference value. If the difference value is less than or equal to 0, the safety evaluation is shown as “an aircraft operation evaluation result being safe”, and if the difference value is greater than 0, the safety evaluation is shown as “the aircraft operation evaluation result is unsafe”.

Based on the same conception, the present invention further provides a multi-dimensional aircraft collision risk calculation and safety evaluation system, including at least one processor and a memory in communication connection with the at least one processor. The memory is configured to store an instruction capable of being performed by the at least one processor. The instruction is performed by the at least one processor, so that the at least one processor performs the above any method.

Compared with the prior art, the present invention has the following beneficial effects.

1. In the present invention, the calculation of multi-dimensional aircraft collision risk probabilities is realized by analyzing the operation of the aircraft between parallel air routes, the operation of the aircraft between layers with a difference of a same flight level and the operation status of the aircraft at the same flight level with a longitudinal distance difference of 6 km.

2. The collision risk probabilities of the aircraft in all dimension directions are calculated, the maximum collision risk probability is calculated, and a determination criterion for a comprehensive safety evaluation of the aircraft is provided based on the maximum collision risk probability.

### BRIEF DESCRIPTION OF THE DRAWINGS

FIG. 1 is a flowchart of a multi-dimensional aircraft collision risk calculation and safety evaluation method according to Embodiment 1 of the present invention;

FIG. 2 is a software interface of a multi-dimensional aircraft collision risk evaluation system according to Embodiment 2 of the present invention;

FIG. 3 is a software interface diagram of an obtained maximum risk value of the multi-dimensional aircraft collision risk evaluation system according to Embodiment 2 of the present invention;

FIG. 4 is an interface diagram of a difference value between a maximum collision probability calculated by software and a safety standard according to Embodiment 2 of the present invention; and

FIG. 5 is an interface diagram of a safety evaluation given by software according to Embodiment 2 of the present invention.

### DETAILED DESCRIPTION

The present invention is described in detail below in combination with experiment examples and specific implementations. However, it should be understood that the scope of the above-mentioned subject of the present invention is not limited to the following embodiments, and all technologies implemented based on the content of the present invention fall within the scope of the present invention.

### Embodiment 1

FIG. 1 is a flowchart of a method corresponding to a multi-dimensional aircraft collision risk evaluation system, including the following steps.

S1: Calculating probabilities of overlapping between an aircraft and other aircraft in three dimensions according to model size parameters of the aircraft, distances between the aircraft and the other aircraft in three dimension directions and a standard deviation of a yaw distance.

S2: Calculating frequencies of loss interval per hour of the aircraft in the three dimension directions according to the probabilities of overlapping between the aircraft and the other aircraft in the three dimensions.

S3: Obtaining risk values of collision probabilities in the three dimension directions according to parameters, such as the frequencies of loss interval per hour of the aircraft in the three dimension directions, a model speed difference value between the aircraft and the other surrounding aircraft, model sizes, logarithms of the aircraft flying in a same direction and in an opposite direction and a collision probability of the aircraft at a same flight level in a perpendicular direction.

S4: Comparing the risk values of the collision probabilities in the three dimension directions to obtain a maximum risk value, where a dimension corresponding to the maximum risk value is a dimension in which the aircraft is most likely to have a collision risk.

S5: Calculating a difference value between the obtained maximum risk value and a safety standard, and determining a safety evaluation grade according to the difference value.

In the step S1, the three dimensions refer to an X axis, a Y axis and a Z axis based on an XYZ coordinate axis. In the three dimensions, the probabilities of overlapping between the aircraft and the other aircraft are calculated respectively, wherein the probability of the overlapping between the aircraft in an X-axis direction is calculated by a formula (1) as follows:

P_{Y}(S_{Y})=∫_{-D}_{₁}^{+D}^{₁}fₛ(x)dx (1)

where D₁=planeA wingspan/2+planeB wingspan/2, S_{Y}=fₛ(x) is a probability density function, which obeys a normal distribution and used to represent a lateral distance between the aircraft in the X-axis direction, and fₛ(x) is calculated by a formula (2) as follows:

$${f}_{s} ( x ) = \frac{1}{{σ}_{d} \sqrt{2 π}} {e}^{\frac{{( x - ( {a}_{2} - {a}_{1} ) )}^{2}}{2 {σ}_{d}^{2}}} \qquad ( 2 )$$

Where a₁ and a₂ are lateral distances of two aircraft that initially pass through a navigation station, and σ d is a standard deviation of a lateral aircraft yaw distance when a distance from the aircraft to the navigation station is d.

The probability of overlapping between the aircraft in a Z-axis direction is calculated as shown in a formula (3),

P_{Z}(S_{Z})=∫_{-D2}^{+D}^{₂}fₛ(z)dz (3)

where D₂=planeA altitude/2+planeB altitude/2, S_{Z}=fₛ(z) is a probability density function, which obeys a normal distribution and used to represent a perpendicular distance between the aircraft in the Z-axis direction, and fₛ(z) is calculated by a formula (4) as follows:

$${f}_{s} ( Z ) = \frac{1}{{γ}_{t} \sqrt{2 π}} {e}^{\frac{{( Z - ( {H}_{2} - {H}_{1} ) )}^{2}}{2 {γ}_{t}^{2}}} \qquad ( 4 )$$

where H₂ and H₁ are initial perpendicular altitudes of two aircraft that initially pass through the navigation station, and γt is a standard deviation of an altitude distance of the aircraft after flight time T.

The probability of overlapping between the aircraft in a Y-axis direction is calculated by a formula (5) as follows:

P_{X}(S_{X})=∫_{-D3}^{+D3}fₛ(y)dy (5)

where D₃=planeA length/2+planeB length/2, S_{X}=fₛ(y) is a probability density function, which obeys a normal distribution and used to represent a longitudinal distance between the aircraft in the Y-axis direction, and fₛ(y) is calculated by a formula (6) as follows:

$${f}_{s} ( y ) = \frac{1}{{κ}_{t} \sqrt{2 π}} {e}^{\frac{{( Z - ( {Y}_{2} - {Y}_{1} ) )}^{2}}{2 {κ}_{t}^{2}}} \qquad ( 6 )$$

where Y₂ and Y₁ are longitudinal distances of two aircraft that initially pass through a navigation station, and κₜ is a standard deviation of a longitudinal distance of the aircraft after flight time T.

In the step S2, the frequencies of loss interval per hour of the aircraft in the three dimension directions are respectively calculated according to the X axis, the Y axis and the Z axis.

The X axis: the frequency of loss interval per hour in the lateral direction is represented by GERH1, and GERH1 is obtained by a formula (7).

$$GERH 1 \times ( 2 \frac{{λ}_{y}}{V} ) = {P}_{Y} ( {S}_{Y} ) \qquad ( 7 )$$

The Z axis: the frequency of loss interval per hour in the perpendicular direction is represented by GERH2, and GERH2 is obtained by a formula (8).

$$GERH 2 \times ( 2 \frac{{λ}_{Z}}{W} ) = {P}_{Z} ( {S}_{Z} ) \qquad ( 8 )$$

The Y axis: the frequency of loss interval per hour in the longitudinal direction is represented by GERH3, and GERH3 is obtained by a formula (9).

$$GERH 3 \times ( 2 \frac{{λ}_{X}}{U} ) = {P}_{X} ( {S}_{X} ) \qquad ( 9 )$$

In the above formulas (7) to (9), U, V and W are relative speeds in longitudinal, lateral and perpendicular directions of an aircraft A passing through an interval region of an aircraft B when the aircraft fly in the same direction, λ_{X}, λ_{Y} and λ_{Z} are a length, a width and a height of a collision box wrapping a real shape of the aircraft, and P_{Y}(S_{Y}), P_{Z}(S_{Z}) and P_{X}(S_{X}) are successively a lateral overlapping probability, a perpendicular overlapping probability and a longitudinal overlapping probability.

In the step S3, the risk values of the collision probabilities of the aircraft in the three dimension directions are respectively calculated according to three dimensions, i.e., the X axis, the Y axis and the Z axis.

### The X Axis:

$${F}_{1} = GERh 1 E ( S ) {P}_{Z} ( 0 ) ( \frac{λ \text{?}}{L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} ) + GERH 1 E ( 0 ) {P}_{Z} ( 0 ) ( \frac{λ \text{?}}{L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} ) \\ \text{?} \text{indicates text missing or illegible when filed} \qquad ( 10 )$$

### The Z Axis:

$${F}_{2} = GERh 2 E ( S ) {P}_{Z} ( 0 ) ( \frac{λ \text{?}}{L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} ) + GERH 2 E ( 0 ) {P}_{Z} ( 0 ) ( \frac{λ \text{?}}{L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} ) \\ \text{?} \text{indicates text missing or illegible when filed} \qquad ( 11 )$$

### The Y Axis:

$${F}_{3} = GERh 3 E ( S ) {P}_{Z} ( 0 ) ( \frac{λ \text{?}}{L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} ) + GERH 3 E ( 0 ) {P}_{Z} ( 0 ) ( \frac{λ \text{?}}{L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} ) \\ \text{?} \text{indicates text missing or illegible when filed} \qquad ( 12 )$$

where GERH1, GERH2 and GERH3 are the frequencies of loss interval per hour in the lateral, perpendicular and longitudinal directions, P_{Z}(0) is the probability of collision between two aircraft at a same flight level, and λ_{X}, λ_{Y} and λ_{Z} are a length, a width and a height of a collision box wrapping a real shape of the aircraft. U₁, V₁ and W₁ are relative speeds of the aircraft in the longitudinal, lateral and perpendicular directions in a process that the aircraft A, flying in the same direction, passes through the interval region of the aircraft B when the problem about the longitudinal distance is evaluated; U₂, V₂ and W₂ are relative speeds of the aircraft in the longitudinal, lateral and perpendicular directions in a process that the aircraft A, flying in the same direction, passes through the interval region of the aircraft B when the problem about the perpendicular distance is evaluated; and U₃, V₃ and W₃ are relative speeds of the aircraft in the longitudinal, lateral and perpendicular directions in a process that the aircraft A, flying in the same direction, passes through the interval region of the aircraft B when the problem about the longitudinal distance is evaluated. L is a longitudinal interval, and E(S) and E(0) respectively are logarithms of the aircraft flying in the same direction and in the opposite direction.

In the step S5, the obtained maximum risk value is compared with a safety standard value. If a difference value is less than or equal to 0, the safety evaluation is shown as “an aircraft operation evaluation result being safe”. If the difference value is greater than 0, the safety evaluation is shown as “the aircraft operation evaluation result being unsafe”. Therefore, timely flight adjustment is required. A safety regulation of the aircraft in the lateral and perpendicular directions requires that the collision probability cannot exceed 1.5×10⁻⁸/flight hour, and the longitudinal collision probability cannot exceed 1.2×10⁻⁷/flight hour.

### Embodiment 2

It is assumed that at a flight phase of a certain air route, a width between two air routes is a2−a1=32 km, d=45 km, σ0=3.0, λσ=0.03, and aircraft ground speed GS=900 km/h, then T=180 s, it is assumed that V=V₁=V₂=V₃, U=U₁=U₂=U₃, W=W₁=W₂=W₃, and relevant information is found as shown in Table 1:

TABLE 1
Parameter value table

| Parameter | Value |
|---|---|
| E[S] | 0.61 |
| E[0] | 0.01 |
| L | 120 n mile |
| Uat | 480 konts |
| U | 13 konts |
| V | 60 konts |
| W | 1.0 konts |
| Pz(0) | 0.48 |

By using two aircraft B747-300 and A380 as research objects now, B747-300 is at a position A, A380 is at a position B, and a fuselage length, a wingspan length and a fuselage height are obtained by taking an average value of the two aircraft, then λx=71.7 m, λy=69.7 m, and λz=21.7 m, and these parameters are substituted to perform calculation:

$${P}_{Y} ( {S}_{Y} ) = {\int }_{- 0.0697}^{0.0697} \frac{1}{{σ}_{d} \sqrt{2 π}} {e}^{\frac{\text{?}}{\text{?}}} dx = 1.1955 \times {10}^{- 8}$$

$$GERH 1 = \frac{1.1955 \times {10}^{- 8}}{( 2 \times 0.0697 / 60 )} = 5.1456 \times {10}^{- 6}$$

$$\text{?} \text{indicates text missing or illegible when filed}$$

F₁=1.2683×10⁻⁹ time/flight hour

Referring to altitude data of the aircraft, and assuming that an initial altitude difference H2−H1 is 0.72 km, T=180 S, and γt=0.13, then:

$${P}_{Z} ( {S}_{Z} ) = {\int }_{- 0.0217}^{0.0217} \frac{1}{{γ}_{t} \sqrt{2 π}} {e}^{\frac{}{}} dz = 3.3230 \times {10}^{- 8}$$

$$GERH 2 = \frac{3.3230 \times {10}^{- 8}}{( 2 \times 0.00217 \text{/} 1 )} = 7.6567 \times {10}^{- 7}$$

F₂=1.8873×10⁻¹⁰ time/flight hour

Referring to speed data of the aircraft, and assuming that an interval distance Y₂−Y₁ between the front and rear aircraft is 6.2 km, T=180 S, and κₜ=1.7, then:

$$Px ( Sx ) = {\int }_{- 0.0717}^{0.0717} \frac{1}{{κ}_{t} \sqrt{2 π}} {e}^{\frac{{( Z - ( {Y}_{2} - {Y}_{1} ) )}^{2}}{2 {κ}_{t}^{2}}} dy = 7.0360 \times {10}^{- 6}$$

$$GERH3 = \frac{7.0360 \times {10}^{- 6}}{( 2 \times 0.0717 \text{/} 13 )} = 6.3785 \times {10}^{- 4}$$

F₃=7.0548×10⁻⁸ time/flight hour

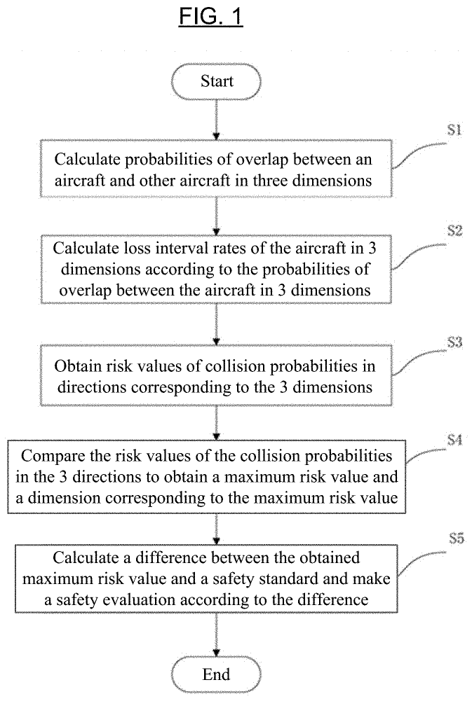

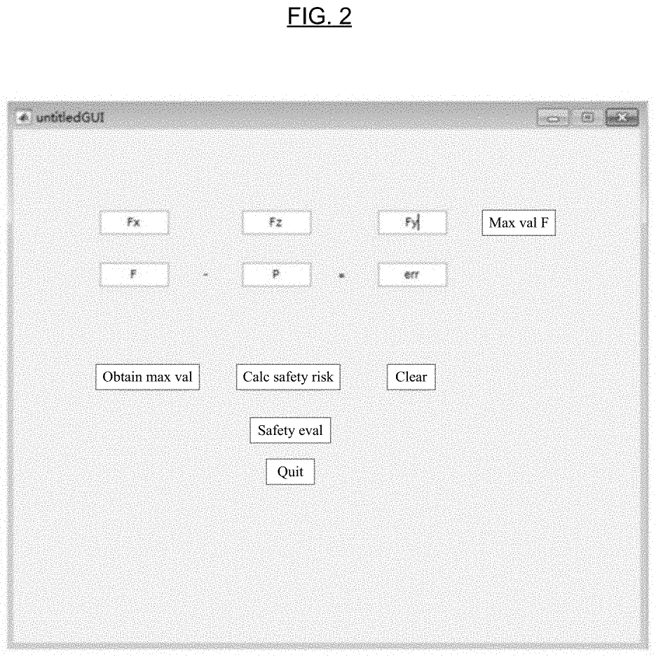

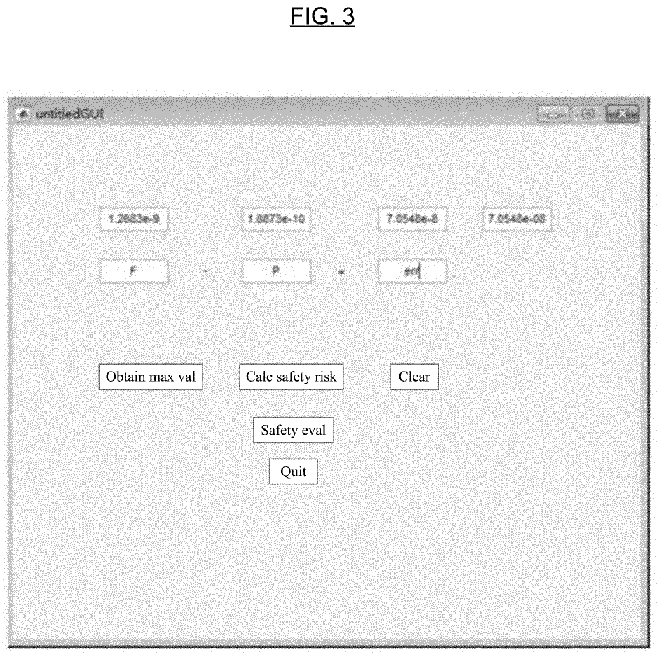

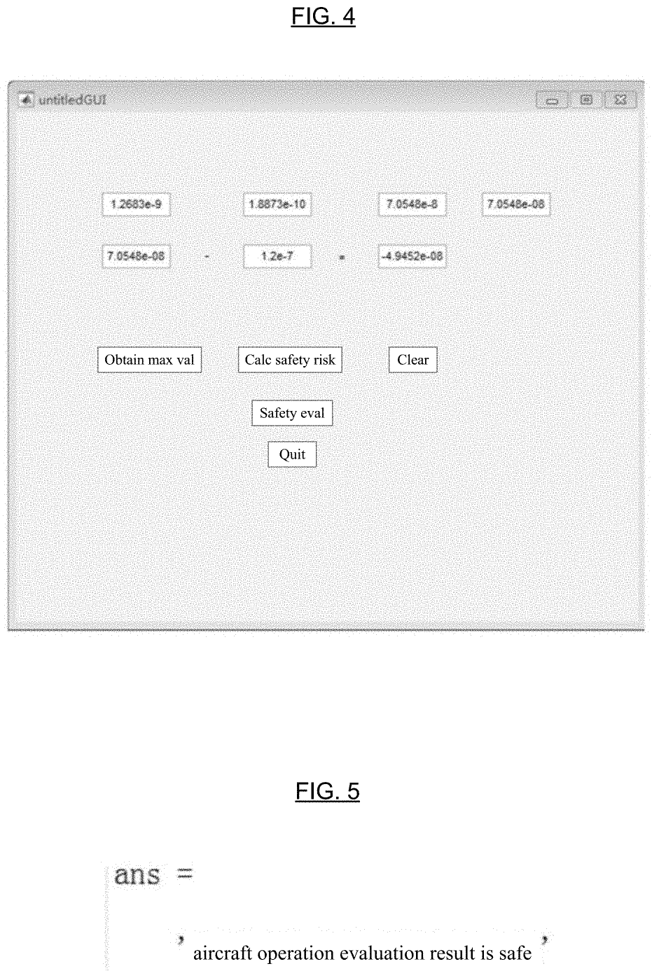

By substituting the above data into the multi-dimensional aircraft collision risk evaluation system, the maximum collision risk value can be obtained, a safety risk is calculated, and the safety evaluation is given. Referring to relevant regulations, the safety regulation of the aircraft in the lateral and perpendicular directions requires that the collision probability cannot exceed 1.5×10⁻⁸ times/flight hour, and the longitudinal collision probability cannot exceed 1.2×10⁻⁷ times/flight hour. FIG. 2 is a software interface of the multi-dimensional aircraft collision risk evaluation system. FIG. 3 is a software interface diagram of an obtained maximum risk value of the multi-dimensional aircraft collision risk evaluation system. FIG. 4 is an interface diagram of a difference value between a maximum collision probability calculated by software and a safety standard. FIG. 5 is an interface of a safety evaluation given by the software.

The hardware to execute the above-described software may include a conventional, off-the-shelf laptop, notebook or desktop computer, and conventional software capable of expressing computational mathematics using relatively large data sets (e.g., MATLAB 2018a computational mathematics software or above) installed thereon. The computer includes a processor (e.g., an Intel CORE i5-3230m processor), memory accessible by the processor (e.g., 4 GB or more of random access memory and/or solid state memory), and a graphics card or graphics processor (e.g., an NVIDIA GEFORCE GT 720M or later graphics processor) configured to display object code encoded by the software on a conventional display and/or monitor.

The present software can acquire information from air traffic controllers' conventional performance of radar control based on ADS-B monitoring, which can obtain real-time information such as aircraft speed, altitude and distance between aircraft. The present software can include the size and length of the aircraft (e.g., programmed into the software or memory, updated as model data or with actual data at the time of scheduling the aircraft for a flight, etc.). The data is fed into the software, and the software calculates the probability of a collision between two planes as described herein. When the collision probability calculated by the software is greater than a specified safety standard, then there is a risk of a collision between the aircraft. In this case, the air traffic controller (who monitors the output displayed from the software) can send this information to the aircraft pilots via HF/VHF communication or a controller-pilot data link communications (CPDLC) system. At the same time, the air traffic controller can also provide air traffic control services for the airplanes by exercising their right to control airplanes. The air traffic controller can then guide the flight track of airplanes by radar, adjust the flight interval between two airplanes, and avoid collisions.

1. A non-transitory computer-readable medium containing a set of instructions multi-dimensional aircraft collision risk evaluation system, wherein the set of instructions, when executed by the a processor, are adapted to:
calculate probabilities of overlapping between a first aircraft and one or more second aircraft in three dimensions according to model size parameters of the first aircraft, distances between the first aircraft and the one or more second aircraft in directions corresponding to the three dimensions, and a standard deviation of a yaw distance;
calculate loss interval rates of the first aircraft in three dimensions according to the probabilities of overlapping between the first aircraft and the one or more second aircraft in the three dimensions;
obtain probabilities of collision between the first aircraft and the one or more second aircraft in the directions corresponding to the three dimensions according to frequencies of loss interval per hour of the first aircraft in the directions corresponding to the three dimensions, a model speed difference value between the first aircraft and the one or more second surrounding aircraft, model sizes, logarithms of the one or more second aircraft flying in a same direction and in an opposite direction and a collision probability of the aircraft at a same flight level in a perpendicular direction;
compare probabilities of collision of the first aircraft in the three dimensions to obtain a maximum probability and a dimension corresponding to the maximum probability; and
calculate a difference value between the maximum probability and a safety standard, and making or giving a safety evaluation according to the difference value.

2. The non-transitory computer-readable medium of claim 1, wherein the probabilities of overlapping between the first aircraft and the one or more second aircraft in the three dimensions are calculated by the following formulas:
a formula of the probability of overlapping between the first aircraft and the one or more second aircraft in an X-axis direction is
P_{Y}(S_{Y})=∫_{-D}_{₁}^{+D}^{₁}fₛ(x)dx
wherein D₁=planeA wingspan/2+planeB wingspan/2, S_{Y}=fₛ(x) is a probability density function that obeys a normal distribution and represents a longitudinal distance between the first aircraft and the one or more second aircraft in the X-axis direction;
a formula of the probability of overlapping between the first aircraft and the one or more second aircraft in a Z-axis direction is
P_{Z}(S_{Z})=∫_{-D2}^{+D}^{₂}fₛ(z)dx
wherein D₂=planeA altitude/2+planeB altitude/2, S_{Z}=fₛ(z) is a probability density function that obeys a normal distribution and represents a perpendicular distance between the first aircraft and the one or more second aircraft in the Z-axis direction; and
a formula of the probability of overlapping between the first aircraft and the one or more second aircraft in a Y-axis direction is
P_{X}(S_{X})=∫_{-D3}^{+D3}fₛ(y)dy
wherein D3 planeA length/2+planeB length/2, S_{X}=fₛ(y) is a probability density function, which obeys a normal distribution and used to represent a longitudinal distance between the first aircraft and the one or more second aircraft in the Y-axis direction.

3. The non-transitory computer-readable medium of claim 2, characterized in that fₛ(x) is calculated as follows:
$${f}_{s} ( x ) = \frac{1}{{σ}_{d} \sqrt{2 π}} {e}^{- \frac{{( x - {a}_{2} - {a}_{1} ) )}^{2}}{2 σ \text{?}}}$$
$$\text{?} \text{indicates text missing or illegible when filed}$$
wherein a₂ and a₁ are lateral distances of two of the first aircraft and the one or more second aircraft that initially pass a navigation station, and σ_{d} is a standard deviation of a lateral aircraft yaw distance when a distance from the first aircraft to the navigation station is d.

4. The non-transitory computer-readable medium of claim 2, wherein that fₛ(z) is calculated as follows:
wherein H₂ and H₁ are initial perpendicular altitudes of two of the first aircraft
$${f}_{x} ( Z ) = \frac{1}{{γ}_{t} \sqrt{2 π}} {e}^{\frac{{( Z - ( {H}_{2} - {H}_{1} ) )}^{2}}{2 {γ}_{t}^{2}}}$$
and the one or more second aircraft that initially pass a navigation station, and γₜ is a standard deviation of an altitude distance of the first aircraft after flight time T.

5. The non-transitory computer-readable medium of claim 2, wherein that fₛ(y) is calculated as follows:
$${f}_{s} ( y ) = \frac{1}{{κ}_{t} \sqrt{2 π}} {e}^{\frac{{( Z - ( {Y}_{2} - {Y}_{1} ) )}^{2}}{2 {κ}_{t}^{2}}}$$
wherein Y₂ and Y₁ are longitudinal distances of two of the first aircraft and the one or more second aircraft that initially pass a navigation station, and κₜ is a standard deviation of a longitudinal distance of the first aircraft after flight time T.

6. The non-transitory computer-readable medium of claim 1, wherein the loss interval rates of the first aircraft in the three dimensions are calculated according to an X axis, a Y axis and a Z axis, according to formulas as follows:
the X axis:
$$GERH 1 \times ( 2 \frac{{λ}_{y}}{V} ) = {P}_{Y} ( {S}_{Y} )$$
the Z axis:
$$GERH 2 \times ( 2 \frac{{λ}_{Z}}{W} ) = {P}_{Z} ( {S}_{Z} )$$
the Y axis:
$$GERH 3 \times ( 2 \frac{{λ}_{X}}{U} ) = {P}_{X} ( {S}_{X} )$$
wherein GERH1 represents a frequency of loss interval per hour in a lateral direction, GERH2 represents a frequency of loss interval per hour in a perpendicular direction, GERH3 represents a frequency of loss interval per hour in a longitudinal direction, U, V and W are relative speeds in the longitudinal direction, the lateral direction and the perpendicular direction of an aircraft A passing through an interval region of an aircraft B when the aircraft A and the aircraft B fly in the same direction, λ_{X}, λ_{Y} and λ_{Z} are a length, a width and a height of a collision box wrapping a real shape of the first aircraft, and P_{Y}(S_{Y}), P_{Z}(S_{Z}) and P_{X}(S_{X}) are respectively a lateral overlapping probability, a perpendicular overlapping probability and a longitudinal overlapping probability.

7. The non-transitory computer-readable medium of claim 1, wherein the probabilities of collision between the first aircraft and the one or more second aircraft in the directions corresponding to the three dimensions are respectively calculated according to the X axis, the Y axis and the Z axis, wherein
in the X axis:
$${F}_{1} = GERh 1 E ( S ) {P}_{Z} ( 0 ) ( \frac{λ \text{?}}{L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} ) + GERH 1 E ( 0 ) {P}_{Z} ( 0 ) ( \frac{λ \text{?}}{L} ) ( \frac{λ \text{?}}{V} ) ( \frac{{U}_{1}}{λ \text{?}} + \frac{{V}_{1}}{λ \text{?}} + \frac{{W}_{1}}{λ \text{?}} )$$
$$\text{?} \text{indicates text missing or illegible when filed}$$
in the Z axis:
$${F}_{2} = GERh 2 E ( S ) {P}_{Z} ( 0 ) ( \frac{λ \text{?}}{L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} ) + GERH 2 E ( 0 ) {P}_{Z} ( 0 ) ( \frac{λ \text{?}}{L} ) ( \frac{λ \text{?}}{V} ) ( \frac{{U}_{2}}{λ \text{?}} + \frac{{V}_{2}}{λ \text{?}} + \frac{{W}_{2}}{λ \text{?}} )$$
$$\text{?} \text{indicates text missing or illegible when filed}$$
in the Y axis:
$${F}_{3} = GERh 3 E ( S ) {P}_{Z} ( 0 ) ( \frac{λ \text{?}}{L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} ) + GERH 3 E ( 0 ) {P}_{Z} ( 0 ) ( \frac{λ \text{?}}{L} ) ( \frac{λ \text{?}}{V} ) ( \frac{{U}_{3}}{λ \text{?}} + \frac{{V}_{3}}{λ \text{?}} + \frac{{W}_{3}}{λ \text{?}} )$$
$$\text{?} \text{indicates text missing or illegible when filed}$$
wherein GERH1, GERH2 and GERH3 are frequencies of loss interval per hour in lateral, perpendicular and longitudinal directions; P_{Z}(0) is probability of collision between two aircraft at a same flight level; λ_{X}, λ_{Y} and λ_{Z} are a length, a width and a height of a collision box wrapping a real shape of the first aircraft; U₁, V₁ and W₁ are relative speeds of an aircraft A and an aircraft B in the longitudinal, lateral and perpendicular directions in a process in which the aircraft A, flying in a same direction, passes through an interval region of the aircraft B when a longitudinal distance is evaluated; U₂, V₂ and W₂ are relative speeds of the aircraft A and the aircraft B in the longitudinal, lateral and perpendicular directions in the process in which the aircraft A, flying in the same direction, passes through the interval region of the aircraft B when a perpendicular distance is evaluated; U₃, V₃ and W₃ are relative speeds of the aircraft A and the aircraft B in the longitudinal, lateral and perpendicular directions in the process in which the aircraft A, flying in the same direction, passes through the interval region of the aircraft B when a longitudinal distance is evaluated; L is a longitudinal interval; and E(S) and E(0) respectively are logarithms of the one or more second aircraft flying in the same direction and in the opposite direction.

8. The non-transitory computer-readable medium of claim 1, wherein calculating the difference value between the maximum probability and the safety standard, and making or giving the safety evaluation comprises:
subtracting a safety standard value from the maximum probability to obtain the difference value, wherein when the difference value is less than or equal to 0, the safety evaluation indicates that an aircraft operation evaluation result is safe, and when the difference value is greater than 0, the safety evaluation indicates that the aircraft operation evaluation result is unsafe.

9. The non-transitory computer-readable medium of claim 1, wherein the one or more second aircrafts flying in the same direction are flying in the same direction as the first aircraft, the one or more second aircrafts flying in the opposite direction are flying in the opposite direction as the first aircraft, and the collision probability of the aircraft at the same flight level is the collision probability of the first aircraft with the one or more second aircraft at the same flight level.

10. The non-transitory computer-readable medium of claim 6, wherein the aircraft A and the aircraft B are the first aircraft and one of the one or more second aircraft.

11. The non-transitory computer-readable medium of claim 7, wherein the aircraft A and the aircraft B are the first aircraft and one of the one or more second aircraft.

12. A multi-dimensional aircraft collision risk calculation and safety evaluation system, comprising at least one processor and a memory in communication connection with the at least one processor; wherein the memory includes the non-transitory computer-readable medium of claim 1.

13. The aircraft collision risk calculation and safety evaluation system of claim 12, further comprising a display and/or monitor and a graphics card or graphics processor configured to display object code encoded by the computer-readable instructions on the display and/or monitor.
